(19) United States
(12) Patent Application Publication
(10) Pub. No.: US 2026/0281857 A1
(43) Pub. Date: Sep. 17, 2026

(54) SEAMLESS ROAMING FOR A NON-PRIMARY CHANNEL ACCESS CAPABLE STATION

(71) Applicant: Nokia Technologies Oy, Espoo (FI)

(72) Inventors: Eda GENC, Espoo (FI); Salvatore TALARICO, Sunnyvale, CA (US); Prabodh VARSHNEY, Dallas, TX (US); Mika KASSLIN, Espoo (FI)

(21) Appl. No.: 19/076,156

(22) Filed: Mar. 11, 2025

(51) Int. Cl. H04W 36/18; H04W 36/00

(52) U.S. Cl. CPC H04W 36/18; H04W 36/0072; H04W 36/008357

(57) ABSTRACT

Embodiments of the present disclosure relate to seamless roaming for a NPCA capable station. In an aspect, an apparatus may transmit, to a first AP MLD, a seamless roaming request for transitioning a link from the first AP MLD to a second AP MLD. The apparatus may receive first information related to NPCA.

### FIELD

Various example embodiments relate to the field of communications, and in particular, to a device, method, apparatus and a computer readable storage medium associated with seamless roaming for a non-primary channel access (NPCA) capable station.

### BACKGROUND

Institute of Electrical and Electronics Engineers (IEEE) 802.11bn (Wi-Fi 8) is a next-generation wireless local area networks (WLAN) amendment, which aims at improving coverage, reliability, and throughput by leveraging multiple access points (APs), enhancing network coordination, and minimizing interference between basic service sets (BSSs).

To achieve this, Task Group bn (TGbn) introduces ultra-high reliability (UHR) capabilities, with medium access control (MAC) and physical layer (PHY) enhancements, to optimize spectrum utilization and seamless connectivity. UHR aims to improve throughput, tail of the latency distribution and jitter, and reliability, particularly in high-density and multi-AP environments. These enhancements are for supporting seamless mobility and efficient resource management, making Wi-Fi networks more adaptable, robust, and scalable for next-generation applications.

### SUMMARY

In general, example embodiments of the present disclosure provide a solution for seamless roaming for a non-primary channel access (NPCA) capable station.

In a first aspect, there is provided an apparatus. The apparatus comprises at least one processor and at least one memory storing instructions that, when executed by the at least one processor, cause the apparatus at least to receive, from a non-access-point (AP) multi-link device (MLD), a seamless roaming request for transitioning a link from the apparatus to a second AP MLD; and transmit, to the non-AP MLD, first information related to NPCA.

In a second aspect, there is provided an apparatus. The apparatus comprises at least one processor and at least one memory storing instructions that, when executed by the at least one processor, cause the apparatus at least to receive, from a first AP MLD, second information related to NPCA.

In a third aspect, there is provided an apparatus. The apparatus comprises at least one processor and at least one memory storing instructions that, when executed by the at least one processor, cause the apparatus at least to transmit, to a first AP MLD, a seamless roaming request for transitioning a link from the first AP MLD to a second AP MLD; and receive first information related to NPCA.

In a fourth aspect, there is provided an apparatus. The apparatus comprises at least one processor and at least one memory storing instructions that, when executed by the at least one processor, cause the apparatus at least to operate on a primary channel of a second AP affiliated with a second AP MLD or a NPCA primary channel of the second AP when a non-AP MLD uses seamless roaming for transitioning a link from a first AP MLD to the second AP MLD based on a status of the second AP, wherein the apparatus is affiliated with the non-AP MLD.

In a fifth aspect, there is provided an apparatus. The apparatus comprises at least one processor and at least one memory storing instructions that, when executed by the at least one processor, cause the apparatus at least to determine a first channel that a second AP affiliated with a second AP MLD is actively using based on at least a condition that the apparatus does not detect any transmissions from the second AP after a non-AP MLD receives seamless roaming response from a first AP MLD, and does not detect any overlapping basic service set (OBSS) on the primary channel of the second AP, wherein the apparatus is affiliated with the non-AP MLD, the non-AP MLD is currently associated with the first AP MLD, the second AP MLD is an AP MLD to which the non-AP MLD is intended to be associated, and the first channel is the primary channel of the second AP or a NPCA primary channel of the second AP; and operate on the first channel.

In a sixth aspect, there is provided an apparatus. The apparatus comprises at least one processor and at least one memory storing instructions that, when executed by the at least one processor, cause the apparatus at least to determine that a non-AP MLD has low latency traffic, wherein the non-AP MLD intends to be associated with a second AP MLD which the apparatus affiliated with; and switch to a NPCA primary channel before receiving a transmission from a station affiliated with the non-AP MLD and transmit a trigger frame on the NPCA primary channel repeatedly with a periodicity for a period or until a transmission from the station affiliated with the non-AP MLD is received based on the determination.

In a seventh aspect, there is provided an apparatus. The apparatus comprises at least one processor and at least one memory storing instructions that, when executed by the at least one processor, cause the apparatus at least to transition a link from a first AP MLD to a second AP MLD; and determine whether to continue to operate in current NPCA status or perform a switch to use a same primary channel as a second AP affiliated with the second AP MLD based on a resource unit (RU) index from a transmission by the second AP.

In an eighth aspect, there is provided a method implemented at an apparatus. The method comprises receiving, from a non-AP MLD, a seamless roaming request for transitioning a link from the apparatus to a second AP MLD; and transmitting, to the non-AP MLD, first information related to NPCA.

In a ninth aspect, there is provided a method implemented at an apparatus. The method comprises receiving, from a first AP MLD, second information related to NPCA.

In a tenth aspect, there is provided a method implemented at an apparatus. The method comprises transmitting, to a first AP MLD, a seamless roaming request for transitioning a link from the first AP MLD to a second AP MLD; and receiving first information related to NPCA.

In an eleventh aspect, there is provided a method implemented at an apparatus. The method comprises operating on a primary channel of a second AP affiliated with a second AP MLD or a NPCA primary channel of the second AP when a non-AP MLD uses seamless roaming for transitioning a link from a first AP MLD to the second AP MLD based on a status of the second AP, wherein the apparatus is affiliated with the non-AP MLD.

In a twelfth aspect, there is provided a method implemented at an apparatus. The method comprises determining a first channel that a second AP affiliated with a second AP MLD is actively using based on at least a condition that the apparatus does not detect any transmissions from the second AP after a non-AP MLD receives seamless roaming response from a first AP MLD, and does not detect any OBSS on the primary channel of the second AP, wherein the apparatus is affiliated with the non-AP MLD, the non-AP MLD is currently associated with the first AP MLD, the second AP MLD is an AP MLD to which the non-AP MLD is intended to be associated, and the first channel is the primary channel of the second AP or a NPCA primary channel of the second AP; and operating on the first channel.

In a thirteenth aspect, there is provided a method implemented at an apparatus. The method comprises determining that a non-AP MLD has low latency traffic, wherein the non-AP MLD intends to be associated with a second AP MLD which the apparatus affiliated with; and switching to a NPCA primary channel before receiving a transmission from a station affiliated with the non-AP MLD and transmitting a trigger frame on the NPCA primary channel repeatedly with a periodicity for a period or until a transmission from the station affiliated with the non-AP MLD is received based on the determination.

In a fourteenth aspect, there is provided a method implemented at an apparatus. The method comprises transitioning a link from a first AP MLD to a second AP MLD; and determining whether to continue to operate in current NPCA status or perform a switch to use a same primary channel as a second AP affiliated with the second AP MLD based on a RU index from a transmission by the second AP.

In a fifteenth aspect, there is provided an apparatus comprising means for receiving, from a non-AP MLD, a seamless roaming request for transitioning a link from the apparatus to a second AP MLD; and means for transmitting, to the non-AP MLD, first information related to NPCA.

In a sixteenth aspect, there is provided an apparatus comprising means for receiving, from a first AP MLD, second information related to NPCA.

In a seventeenth aspect, there is provided an apparatus comprising means for transmitting, to a first AP MLD, a seamless roaming request for transitioning a link from the first AP MLD to a second AP MLD; and means for receiving first information related to NPCA.

In an eighteenth aspect, there is provided an apparatus comprising means for operating on a primary channel of a second AP affiliated with a second AP MLD or a NPCA primary channel of the second AP when a non-AP MLD uses seamless roaming for transitioning a link from a first AP MLD to the second AP MLD based on a status of the second AP, wherein the apparatus is affiliated with the non-AP MLD.

In a nineteenth aspect, there is provided an apparatus comprising means for determining a first channel that a second AP affiliated with a second AP MLD is actively using based on at least a condition that the apparatus does not detect any transmissions from the second AP after a non-AP MLD receives seamless roaming response from a first AP MLD, and does not detect any OBSS on the primary channel of the second AP, wherein the apparatus is affiliated with the non-AP MLD, the non-AP MLD is currently associated with the first AP MLD, the second AP MLD is an AP MLD to which the non-AP MLD is intended to be associated, and the first channel is the primary channel of the second AP or a NPCA primary channel of the second AP; and means for operating on the first channel.

In a twentieth aspect, there is provided an apparatus comprising means for determining that a non-AP MLD has low latency traffic, wherein the non-AP MLD intends to be associated with a second AP MLD which the apparatus affiliated with; and means for switching to a NPCA primary channel before receiving a transmission from a station affiliated with the non-AP MLD and transmitting a trigger frame on the NPCA primary channel repeatedly with a periodicity for a period or until a transmission from the station affiliated with the non-AP MLD is received based on the determination.

In a twenty-first aspect, there is provided an apparatus comprising means for transitioning a link from a first AP MLD to a second AP MLD; and means for determining whether to continue to operate in current NPCA status or perform a switch to use a same primary channel as a second AP affiliated with the second AP MLD based on a RU index from a transmission by the second AP.

In a twenty-second aspect, there is provided a non-transitory computer readable medium comprising program instructions that, when executed by an apparatus, cause the apparatus to perform at least the method according to any one of the above eight to fourteenth aspect.

In a twenty-third aspect, there is provided a computer program comprising program instructions for causing an apparatus to perform at least the method according to any one of the above eight to fourteenth aspect.

In a twenty-fourth aspect, there is provided an apparatus comprising receiving circuitry configured to receive, from a non-AP MLD, a seamless roaming request for transitioning a link from the apparatus to a second AP MLD; and transmitting circuitry configured to transmit, to the non-AP MLD, first information related to NPCA.

In a twenty-fifth aspect, there is provided an apparatus comprising receiving circuitry configured to receive, from a first AP MLD, second information related to NPCA.

In a twenty-sixth aspect, there is provided an apparatus comprising transmitting circuitry configured to transmit, to a first AP MLD, a seamless roaming request for transitioning a link from the first AP MLD to a second AP MLD; and receiving circuitry configured to receive first information related to NPCA.

In a twenty-seventh aspect, there is provided an apparatus comprising operating circuitry configured to operate on a primary channel of a second AP affiliated with a second AP MLD or a NPCA primary channel of the second AP when a non-AP MLD uses seamless roaming for transitioning a link from a first AP MLD to the second AP MLD based on a status of the second AP, wherein the apparatus is affiliated with the non-AP MLD.

It is to be understood that the summary section is not intended to identify key or essential features of embodiments of the present disclosure, nor is it intended to be used to limit the scope of the present disclosure. Other features of the present disclosure will become easily comprehensible through the following description.

### BRIEF DESCRIPTION OF THE DRAWINGS

Some example embodiments will now be described with reference to the accompanying drawings, in which:

FIG. 1A illustrates an example communication environment in which embodiments of the present disclosure may be implemented;

FIG. 1B illustrates an example of non-primary channel access according to some embodiments of the present disclosure;

FIG. 1C illustrates an example of interaction between seamless roaming and NPCA mechanisms according to some embodiments of the present disclosure;

FIG. 1D illustrates an example scenario of interaction between seamless roaming and NPCA mechanisms according to some embodiments of the present disclosure;

FIG. 1E illustrates another example scenario of interaction between seamless roaming and NPCA mechanisms according to some embodiments of the present disclosure;

FIG. 1F illustrates a solution for seamless roaming for a NPCA capable station;

FIG. 2 illustrates a flowchart illustrating a process for NPCA related information exchange according to some embodiments of the present disclosure;

FIG. 3 illustrates a flowchart illustrating a process for joint enablement based on capability and enablement of AP MLD according to some embodiments of the present disclosure;

FIG. 4 illustrates a flowchart illustrating a process for primary channel selection according to some embodiments of the present disclosure;

FIG. 5 illustrates a flowchart illustrating a process for first channel determination according to some embodiments of the present disclosure;

FIG. 6 illustrates a flowchart illustrating a process for NPCA status determination according to some embodiments of the present disclosure;

FIG. 7 illustrates a flowchart of a method implemented at an apparatus according to some embodiments of the present disclosure;

FIG. 8 illustrates a flowchart of a method implemented at an apparatus according to some embodiments of the present disclosure;

FIG. 9 illustrates a flowchart of a method implemented at an apparatus according to some embodiments of the present disclosure;

FIG. 10 illustrates a flowchart of a method implemented at an apparatus according to some embodiments of the present disclosure;

FIG. 11 illustrates a flowchart of a method implemented at an apparatus according to some embodiments of the present disclosure;

FIG. 12 illustrates a flowchart of a method implemented at an apparatus according to some embodiments of the present disclosure;

FIG. 13 illustrates a flowchart of a method implemented at an apparatus according to some embodiments of the present disclosure;

FIG. 14 illustrates a simplified block diagram of an apparatus that is suitable for implementing embodiments of the present disclosure; and

FIG. 15 illustrates a block diagram of an example computer readable medium in accordance with some embodiments of the present disclosure.

Throughout the drawings, the same or similar reference numerals represent the same or similar element.

### DETAILED DESCRIPTION

Principles of the present disclosure will now be described with reference to some example embodiments. It is to be understood that these embodiments are described only for the purpose of illustration and help those skilled in the art to understand and implement the present disclosure, without suggesting any limitation as to the scope of the disclosure. The disclosure described herein can be implemented in various manners other than the ones described below.

In the following description and claims, unless defined otherwise, all technical and scientific terms used herein have the same meaning as commonly understood by one of ordinary skills in the art to which this disclosure belongs.

References in the present disclosure to “one embodiment,” “an embodiment,” “an example embodiment,” and the like indicate that the embodiment described may include a particular feature, structure, or characteristic, but it is not necessary that every embodiment includes the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to affect such feature, structure, or characteristic in connection with other embodiments whether or not explicitly described.

It shall be understood that although the terms “first” and “second” etc. may be used herein to describe various elements, these elements should not be limited by these terms. These terms are only used to distinguish one element from another. For example, a first element could be termed a second element, and similarly, a second element could be termed a first element, without departing from the scope of example embodiments. As used herein, the term “and/or” includes any and all combinations of one or more of the listed terms.

The terminology used herein is for the purpose of describing particular embodiments only and is not intended to be limiting of example embodiments. As used herein, the singular forms “a”, “an” and “the” are intended to include the plural forms as well, unless the context clearly indicates otherwise. It will be further understood that the terms “comprises”, “comprising”, “has”, “having”, “includes” and/or “including”, when used herein, specify the presence of stated features, elements, and/or components etc., but do not preclude the presence or addition of one or more other features, elements, components and/or combinations thereof. As used herein, “at least one of the following: <a list of two or more elements>” and “at least one of <a list of two or more elements>” and similar wording, where the list of two or more elements are joined by “and” or “or”, mean at least any one of the elements, or at least any two or more of the elements, or at least all the elements.

As used in this application, the term “circuitry” may refer to one or more or all of the following:
(a) hardware-only circuit implementations (such as implementations in only analog and/or digital circuitry) and
(b) combinations of hardware circuits and software, such as (as applicable):
   (i) a combination of analog and/or digital hardware circuit(s) with software/firmware and
   (ii) any portions of hardware processor(s) with software (including digital signal processor(s)), software, and memory(ies) that work together to cause an apparatus, such as a mobile phone or server, to perform various functions) and
(c) hardware circuit(s) and or processor(s), such as a microprocessor(s) or a portion of a microprocessor(s), that requires software (e.g., firmware) for operation, but the software may not be present when it is not needed for operation.

This definition of circuitry applies to all uses of this term in this application, including in any claims. As a further example, as used in this application, the term circuitry also covers an implementation of merely a hardware circuit or processor (or multiple processors) or portion of a hardware circuit or processor and its (or their) accompanying software and/or firmware. The term circuitry also covers, for example and if applicable to the particular claim element, a baseband integrated circuit or processor integrated circuit for a mobile device or a similar integrated circuit in server, a cellular network device, or other computing or network device.

As used herein, the term “communication network” refers to a network following any suitable communication standards, such as NR radio, Long Term Evolution (LTE), LTE-Advanced (LTE-A), Wideband Code Division Multiple Access (WCDMA), High-Speed Packet Access (HSPA), Narrow Band Internet of Things (NB-IoT), Wi-Fi and so on. Furthermore, the communications between a terminal device and a network device in the communication network may be performed according to any suitable generation communication protocols, including, but not limited to, the first generation (1G), the second generation (2G), 2.5G, 2.75G, the third generation (3G), the fourth generation (4G), 4.5G, the fifth generation (5G) communication protocols, the future sixth generation (6G) communication protocols, and/or any other protocols either currently known or to be developed in the future. Embodiments of the present disclosure may be applied in various communication systems. Given the rapid development in communications, there will of course also be future type communication technologies and systems with which the present disclosure may be embodied. It should not be seen as limiting the scope of the present disclosure to only the aforementioned system.

As used herein, the term “network device” refers to a node in a communication network via which a terminal device accesses the network and receives services therefrom. The network device may refer to a base station (BS) or an access point (AP), for example, a node B (NodeB or NB), an evolved NodeB (eNodeB or eNB), a NR NB (also referred to as a gNB), a remote radio unit (RRU), a radio header (RH), a remote radio head (RRH), a relay, a low power node such as a femto, a pico, and so forth, depending on the applied terminology and technology.

As used herein, the term “terminal device” refers to any end device that may be capable of wireless communication. By way of example rather than limitation, a terminal device may also be referred to as a communication device, user equipment (UE), a subscriber station, a portable subscriber station, a mobile station (MS), or an access terminal (AT). The terminal device may include, but not limited to, a mobile phone, a cellular phone, a smart phone, voice over IP (VoIP) phones, wireless local loop phones, a tablet, a wearable terminal device, a personal digital assistant (PDA), portable computers, desktop computer, image capture terminal devices such as digital cameras, gaming terminal devices, music storage and playback appliances, vehicle-mounted wireless terminal devices, wireless endpoints, mobile stations, laptop-embedded equipment (LEE), laptop-mounted equipment (LME), USB dongles, smart devices, wireless customer-premises equipment (CPE), an Internet of Things (IoT) device, a watch or other wearable, a head-mounted display (HMD), a vehicle, a drone, a medical device and applications (e.g., remote surgery), an industrial device and applications (e.g., a robot and/or other wireless devices operating in an industrial and/or an automated processing chain contexts), a consumer electronics device, a device operating on commercial and/or industrial wireless networks, and the like. In the following description, the terms “terminal device”, “communication device”, “terminal”, “user equipment” and “UE” may be used interchangeably.

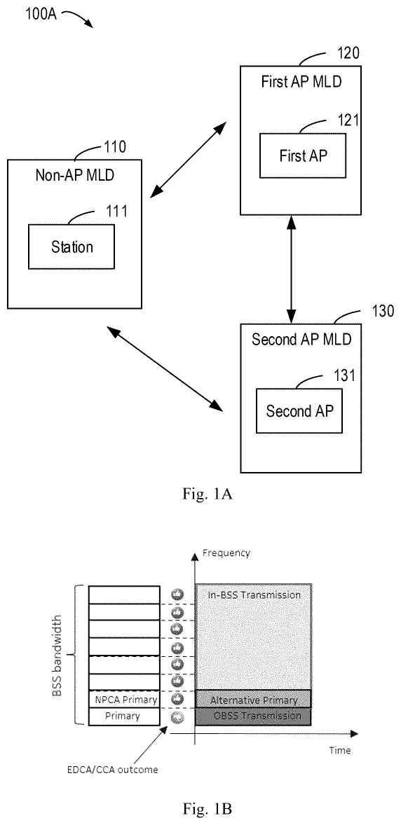

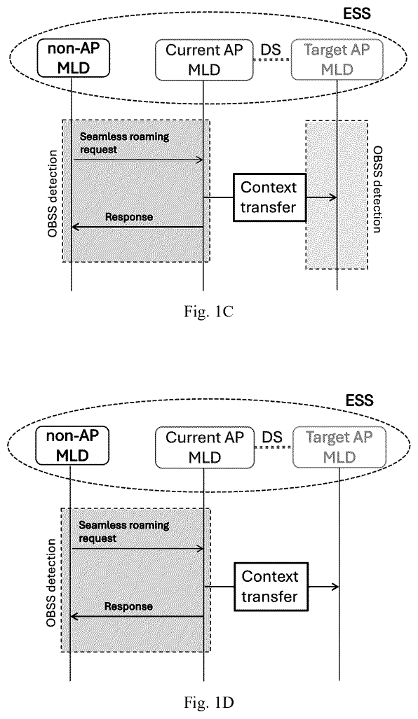

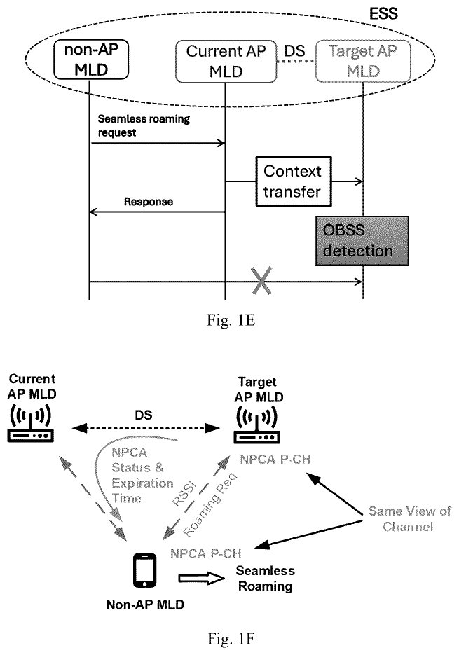

Principles and embodiments of the present disclosure will be described in detail below with reference to the accompanying drawings. Reference is first made to FIG. 1A, which illustrates an example communication environment 100A in which embodiments of the present disclosure may be implemented. The system 100 comprises a non-AP MLD 110, a first AP MLD 120, and a second AP MLD 130. It will be understood that an MLD is a logical entity. An MLD acting as an AP entity may be referred to as an AP MLD, and an MLD acting as a non-AP STA entity may be referred to as a non-AP MLD.

The first AP MLD 120 may also be referred to as a current AP MLD. The current AP MLD is the AP MLD with which the non-AP MLD 110 that intends to roam is currently associated with before undergoing through the seamless roaming process. The first AP MLD 120 has affiliated a first AP 121. The first AP 121 refers to the AP affiliated with the first AP MLD that the station 111 affiliated with the non-AP MLD 110 is associated with.

The second AP MLD 130 may also be referred to as a target AP MLD. The target AP MLD is the AP MLD to which the non-AP MLD 110 that intends to roam will be associated with after the seamless roaming process. The second AP MLD 130 has affiliated a second AP 131. The second AP 131 refers to the AP affiliated with the second AP MLD 130 that the station 111 affiliated with the non-AP MLD 110 will setup a link using seamless roaming mechanism.

The non-AP MLD 110 has affiliated a non-AP station (STA) 111. Hereinafter, a non-AP STA is also referred to as STA for brevity. The station 110 is associated with the first AP 121 affiliated with the first AP MLD 120 that intends to roam to the second AP MLD 130 for establishing a link with the second AP 131 affiliated with the second AP MLD 130.

It is to be understood that the number of the non-AP STAs affiliated with the non-AP MLD 110 and the number of the APs affiliated with the AP MLD 120 as shown in FIG. 1A are only for the purpose of illustration without suggesting any limitations. The communication environment 100A may include any suitable number of STAs affiliated with the non-AP MLD 110 and any suitable number of APs affiliated with the AP MLD 120 adapted for implementing embodiments of the present disclosure. In addition, it is to be understood that the number of the non-AP MLDs as shown in FIG. 1A is also only for the purpose of illustration without suggesting any limitations. The communication environment 100A may include any suitable number of non-AP MLDs adapted for implementing embodiments of the present disclosure. In some embodiments, the AP MLD 120 may establish links with a plurality of non-AP MLDs.

FIG. 1B illustrates an example of non-primary channel access in accordance with some example embodiments of the present disclosure. NPCA is a mechanism that is introduced and under development in IEEE 802.11 TGbn. The NPCA mechanism is designed to address situations where a primary channel of a BSS is occupied due to OBSS transmissions or other conditions to be defined by the task group. IEEE 802.11 devices use primary channel for control and management frames, while data transmissions can occur on the primary channel alone or across multiple bonded channels, called secondary channels. Based on current design, if a secondary channel is assessed to be idle during an enhanced distributed channel access (EDCA) procedure, preamble puncturing can be applied. However, if the primary channel is assessed to be idle during the EDCA procedure, the whole transmission cannot be performed. This leads to high spectrum inefficiency and possible high latencies.

To address this issue, NPCA enables APs and Stations (STAs) to temporarily switch to an alternative primary channel, when the primary channel is unavailable, called NPCA primary channel, as shown in FIG. 1B. The AP announces NPCA capability and related parameters (e.g., NPCA primary channel) in Beacon and Probe Response frames, allowing devices to prepare for potential channel transitions. When an OBSS control frame or an OBSS High Efficiency (HE)/Extremely High Throughput (EHT)/UHR Physical Protocol Data Unit (PPDU) that overlaps with the primary channel is detected, a STA switches its transmissions by using an NPCA primary channel. Once the primary channel becomes available, a STA returns to the primary channel.

Seamless roaming in IEEE 802.11 TGbn is designed to ensure that a non-AP MLD remains in state 4 (authenticated and associated) while transitioning a link from a current AP MLD to a target AP MLD within an extended service set (ESS). This mechanism enables low-latency, disruption-free handovers, ensuring that ongoing data sessions and connectivity are not interrupted when a non-AP MLD moves between APs.

A non-AP MLD makes the decision to initiate seamless roaming based on the BSS information it receives. This information may be obtained among other methods through passive scanning via Beacon frames, active scanning via Probe Response frames, or through additional mechanisms such as Neighbor Reports (as defined in IEEE 802.11k) or BSS Transition Management Requests (as defined in IEEE 802.11v). These mechanisms may be used to allow the non-AP MLD to evaluate potential target AP MLDs, ensuring that the roaming decision is based on signal strength, channel conditions, load balancing, and other network parameters.

Once the non-AP MLD decides to roam, it shall send a request frame to the current AP MLD, signaling the intent to transition to a new AP MLD. In response, the current AP MLD is required to transfer the operational context to the target AP MLD. This context transfer process includes necessary parameters such as security credentials, Quality of Service (QoS) configurations, session state, and other BSS-specific settings, allowing the target AP MLD to seamlessly integrate the roaming non-AP MLD without requiring full reauthentication or reconfiguration. If context transfer is not possible, then context may need to be renegotiated with the target AP MLD to ensure continuity of operations.

After the current AP MLD sends the context transfer to the target AP MLD, the current AP MLD shall send a seamless roaming response to the non-AP MLD. The non-AP MLD may then transition to the new link and continue operation with minimal packet loss. In cases where data forwarding is necessary, the current AP MLD may continue to buffer and forward downlink (DL) data to the target AP MLD for a period, ensuring that the non-AP MLD does not experience delays in data transmission. Similarly, the non-AP MLD may be allowed to retrieve buffered DL frames from the current AP MLD before fully transitioning.

When both the non-AP MLD and the target AP MLD support seamless roaming, depending on their affiliated STAs' and APs' NPCA support and capabilities, certain cases arise where these operations occur simultaneously. In such cases, optimizations are needed to fully leverage the potential of both features and ensure efficient coordination between NPCA transitions and seamless roaming events.

Some problematic scenarios arise from the interaction of these mechanisms. FIG. 1C illustrates an example of interaction between seamless roaming and NPCA mechanisms in accordance with some example embodiments of the present disclosure. The interaction between seamless roaming and NPCA mechanisms varies across different scenarios, including the NPCA state of the APs affiliated with AP MLDs and STA affiliated with non-AP MLD, the conditions under which seamless roaming is initiated, and the scope of context transfer during the transition. As an example, these conditions could be:
a STA affiliated with a non-AP MLD may not be NPCA capable, while the AP affiliated with the target AP MLD supports NPCA.
the AP affiliated with the current AP MLD and target AP affiliated with the target AP MLD may have different NPCA configurations, such as operating on different NPCA primary channels or having NPCA enabled in one but disabled in the other.
both the STA affiliated with a non-AP MLD and APs affiliated with AP MLDs may be NPCA-capable, but only one is actively operating in NPCA mode.
both APs affiliated with AP MLDs are in NPCA mode but under different state (e.g., one is operating on the primary channel and the other in NPCA primary channel).

For all these scenarios, the roaming process is designed to ensure a smooth transition without disrupting the ongoing transmissions.

FIG. 1D illustrates an example scenario of interaction between seamless roaming and NPCA mechanisms in accordance with some example embodiments of the present disclosure. When a non-AP MLD uses seamless roaming for transitioning from the current AP MLD to the target AP MLD, a non-AP MLD sends a request to the current AP MLD for seamless roaming execution as shown in FIG. 1D. After the current AP MLD receives the request from the non-AP MLD, context transfer from the current AP MLD to the target AP MLD takes place. After the context transfer is completed, the current AP MLD sends a response to the non-AP MLD. Once the non-AP MLD receives the response, the link to the target AP MLD is set up.

During seamless roaming operation, if both the STA affiliated with the non-AP MLD and the AP affiliated with the current AP MLD are NPCA capable and detect an OBSS and switch to a NPCA primary channel, seamless roaming operation may get interrupted depending on the time of the switch, NPCA capabilities of the AP affiliated with the target AP MLD, and NPCA related information of each other exchanged and known by the non-AP MLD, the current AP MLD and the target AP MLD.

FIG. 1E illustrates another example scenario of interaction between seamless roaming and NPCA mechanisms in accordance with some example embodiments of the present disclosure. In this case, a non-AP MLD uses seamless roaming for transitioning the link from a current AP MLD to a target AP MLD, and an AP affiliated with the target AP MLD is NPCA capable and detects an OBSS transmission overlapping with its primary channel during the seamless roaming mechanism. When the OBSS is detected before the link between a STA affiliated with the non-AP MLD and the AP affiliated with the target AP MLD is setup, the link transition fails due to the AP affiliated with the target AP MLD operating in NPCA primary channel while the STA affiliated with the non-AP MLD is operating in primary channel of the AP affiliated with the target AP MLD. This causes the non-AP MLD to lose connectivity and have service interruption which is on the contrary with the purpose of seamless roaming mechanism.

FIG. 1F illustrates a state of art solution for seamless roaming for a NPCA capable station. The target AP MLD could exchange its affiliated AP's NPCA status (e.g. whether it operates on the primary or the NPCA primary channel), and an expiration time related to the applicability of the NPCA status via the current AP MLD, and this information could be provided to the non-AP MLD.

However, this approach has limitations as the exchange of this information through a distribution system (DS) and over the air transmission are subject to processing and transmissions delays which may cause inconsistencies as due to these delays the provided NPCA status may have changed by the time it is received at the non-AP MLD.

Among others, an issue addressed by some embodiments of the present disclosure is how to address NPCA and seamless roaming intersection.

According to embodiments of the present disclosure, there is provided a solution for seamless roaming for a NPCA capable station. In an aspect of the solution, an apparatus may transmit, to a first AP MLD, a seamless roaming request for transitioning a link from the first AP MLD to a second AP MLD. The apparatus may receive first information related to NPCA. This solution may optimize interoperability between NPCA and seamless roaming mechanisms.

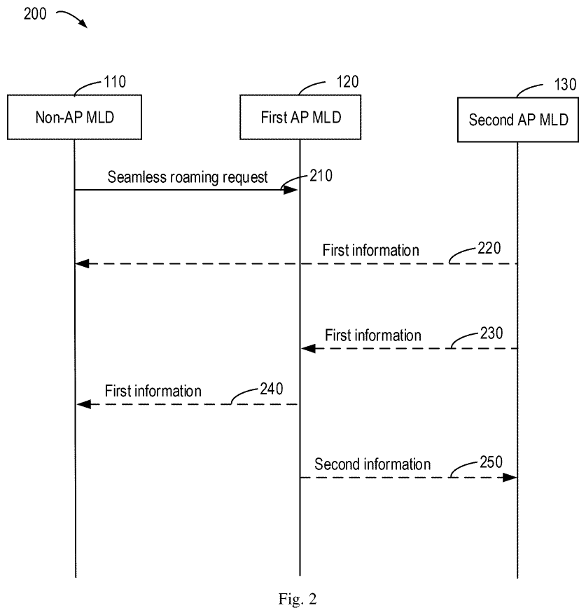

Reference is now made to FIG. 2, which shows a process 200 for NPCA related information exchange according to some embodiments of the present disclosure. For the purpose of discussion, the process 200 will be described with reference to FIG. 1A. The process 200 may involve the non-AP MLD 110, the first AP MLD 120 and the second AP MLD 130 as illustrated in FIG. 1A.

At 210, the non-AP MLD 110 may transmit, to a first AP MLD 120, a seamless roaming request for transitioning a link from the first AP MLD 120 to a second AP MLD 130.

In some embodiments, at 220, the second AP MLD 130 may transmit, to the non-AP MLD 110, first information related to NPCA.

In some embodiments, the first information may comprise: a NPCA capability of a second AP affiliated with the second AP MLD; a NPCA primary channel used by the second AP; operating bandwidth used by the second AP when switching to a NPCA primary channel; a network allocation vector (NAV) of an OBSS detected by the second AP and overlapping with its NPCA primary channel; whether or not the second AP is currently operating on a NPCA primary channel or a primary channel; or any combination thereof.

In some embodiments, the first information transmitted from the second AP MLD 130 to the non-AP MLD 110 is carried on a beacon frame or a management frame (e.g., association or probe frame).

In some other embodiments, at 230, the second AP MLD 130 may transmit the first information to the first AP MLD 120. At 240, the first AP MLD 120 may transmit the first information to the non-AP MLD 110.

In some embodiments, the first information transmitted from the first AP MLD 120 to the non-AP MLD 110 is carried on an initial control response (ICR) or initial control frame (ICF) between the first AP MLD 120 and the non-AP MLD 110, a neighbors report, or a response of the seamless roaming request.

In some embodiments, at 250, the first AP MLD 120 may transmit, to the second AP MLD 130, second information related to NPCA.

In some embodiments, the second information may comprise: a NPCA capability of a first AP affiliated with the apparatus; a NPCA primary channel used by the first AP; operating bandwidth used by the first AP when switching to a NPCA primary channel; a NAV of an OBSS detected by the first AP and overlapping with its NPCA primary channel; whether or not the first AP is currently operating on a NPCA primary channel or a primary channel; or any combination thereof.

In some embodiments, the second information is carried on a context transfer message.

In some embodiments, the first information and/or the second information is transmitted before seamless roaming initiation, for example, in a preparation phase.

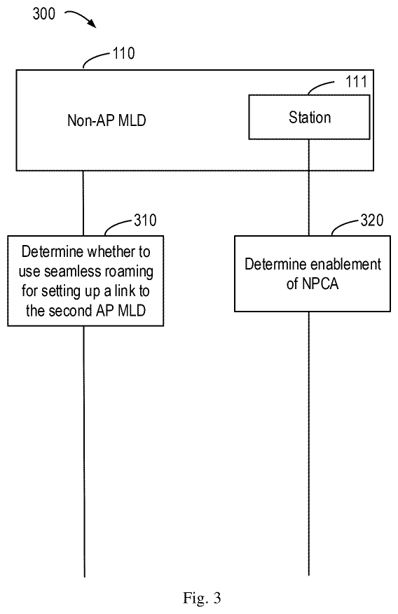

Reference is now made to FIG. 3, which shows a process 300 for joint enablement based on capability and enablement of AP MLD according to some embodiments of the present disclosure. For the purpose of discussion, the process 300 will be described with reference to FIG. 1A. The process 300 may involve the non-AP MLD 110 and the station 111 as illustrated in FIG. 1A.

At 310, the non-AP MLD 110 may determine whether to use seamless roaming for setting up a link to the second AP MLD 130. At 320, the station 111 may determine enablement of NPCA.

In some embodiments, either seamless roaming is used by the non-AP MLD 110 or NPCA is enabled by the station 111. In some other embodiments, seamless roaming is used by the non-AP MLD 110 and NPCA is enabled by the station 111 at the same time.

In some embodiments, the non-AP MLD 110 may support seamless roaming and the station 111 may support NPCA.

In some embodiments, the non-AP MLD 110 may determine whether to use seamless roaming for setting up a link to the second AP MLD 130 and the station 111 may determine enablement of NPCA based on capability or enablement of the first AP 121 and/or the second AP 131.

In some embodiments, the non-AP MLD 110 may determine to use seamless roaming and the station 111 may determine that NPCA is enabled based on a condition that both the first AP 121 and the second AP 131 support NPCA. It is to be understood that the determination may be made regardless of the NPCA primary channel that each of the first AP 121 and the second AP 131 has selected.

In some embodiments, the non-AP MLD 110 may determine to use seamless roaming and the station 111 may determine that NPCA is enabled based on a condition that both the first AP 121 and the second AP 131 support NPCA, and both the first AP 121 and the second AP 131 have selected a same NPCA primary channel.

In some embodiments, the non-AP MLD 110 may determine that seamless roaming is not used for transitioning a link from the first AP MLD 120 to the second AP MLD 130 and the station 111 may determine that NPCA remains enabled based on a condition that both the first AP and the second AP support NPCA, and the first AP 121 and the second AP 131 have selected different NPCA primary channels.

In some embodiments, the station 111 may determine that NPCA is disabled upon roaming based on a condition that the first AP 121 supports NPCA, and the second AP 131 does not support NPCA

In some embodiments, the station 111 may determine that NPCA is enabled upon roaming based on a condition that the first AP 121 does not support NPCA, and the second AP 131 supports NPCA and enables NPCA.

In some embodiments, the station 111 may determine that NPCA is enabled based on a condition that the first AP 121 does not support NPCA, the second AP 131 supports NPCA, and the station 111 have checked that NPCA is enabled in the second AP 131 while setting up a link with the second AP MLD 130 after receiving a seamless roaming response from the first AP MLD 120.

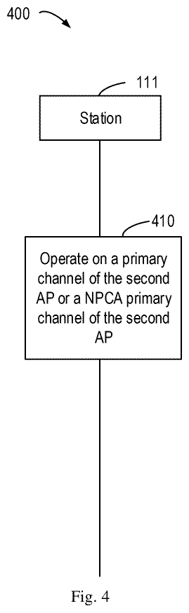

Reference is now made to FIG. 4, which shows a process 400 for primary channel selection according to some embodiments of the present disclosure. For the purpose of discussion, the process 400 will be described with reference to FIG. 1A. The process 400 may involve the station 111 as illustrated in FIG. 1A.

At 410, the station 111 may operate on a primary channel of the second AP 131 or a NPCA primary channel of the second AP 131 when the non-AP MLD 110 uses seamless roaming for transitioning a link from the first AP MLD 120 to the second AP MLD 130 based on a status of the second AP 131. In some embodiments, the station 111 may establish the link with the second AP MLD 130 with the primary channel or the NPCA primary channel.

In some embodiments, the non-AP MLD 110 may support and use seamless roaming, and the station 111 may support and enable NPCA.

In some embodiments, the station 111 may operate on the primary channel of the second AP regardless of a state of the station 111 when connected with the first AP MLD. For example, the station 111 may either operate on the primary channel of the first AP 121 or due to an overlapping OBSS may have switched to an NPCA primary channel.

In some embodiments, the station 111 may switch to operate on a NPCA primary channel of the second AP based on a condition that the station 111 having detected an OBSS which overlaps with the primary channel of the second AP upon switching from the first AP MLD 120 to the second AP MLD 130. In some embodiments, the station 111 may switch to operate on the NPCA primary channel based upon certain present rules.

In some embodiments, the station 111 may continue to operate on the NPCA primary channel of the second AP 131 based on a condition that both the station 111 and the second AP 131 are operating on the same NPCA primary channel.

In some embodiments, the station 111 may update a basic NAV of an OBSS through: assessment of the OBSS; or information from an ICR or ICF between the first AP MLD 120 and the non-AP MLD 110, a beacon frame, a management frame (e.g., association or probe frame), neighbors report, or a seamless roaming response from the first AP MLD 120 to the non-AP MLD 110 when requesting to roam.

In some embodiments, the station 111 may operate on the primary channel of the second AP 131 based on a condition that the station 111 and the second AP 131 are operating on different NPCA primary channels. For example, the station 111 may operate on the NPCA primary channel before roaming, and switch back to primary channel of the second AP 131 after roaming.

In some embodiments, the station 111 may operate on the NPCA primary channel of the second AP based on a condition that the station 111 and the second AP are operating on different NPCA primary channels. For example, the station 111 may operate on the NPCA primary channel before roaming, and switch to the NPCA primary channel of the second AP 131 after roaming.

In some embodiments, the station 111 may update a basic NAV of an OBSS through: assessment of the OBSS; or information from a seamless roaming response from the first AP MLD 120 when requesting to roam.

In some embodiments, the station 111 may operate on the NPCA primary channel of the second AP 131 based on a condition that a basic NAV of an OBSS affecting the primary channel of the second AP 131, which is retrieved in a seamless roaming response from the first AP MLD 120 when requesting to roam, is longer than a first value. For example, the station 111 may operate on the NPCA primary channel before roaming, and switch to the NPCA primary channel of the second AP 131 after roaming.

In some embodiments, the station 111 may operate on the primary channel of the second AP 131 based on a condition that a basic NAV of an OBSS affecting the primary channel of the second AP 131, which is retrieved in a seamless roaming response from the first AP MLD 120 when requesting to roam, is shorter than a first value. For example, the station 111 may operate on the NPCA primary channel before roaming, and switch to the primary channel of the second AP 131 after roaming.

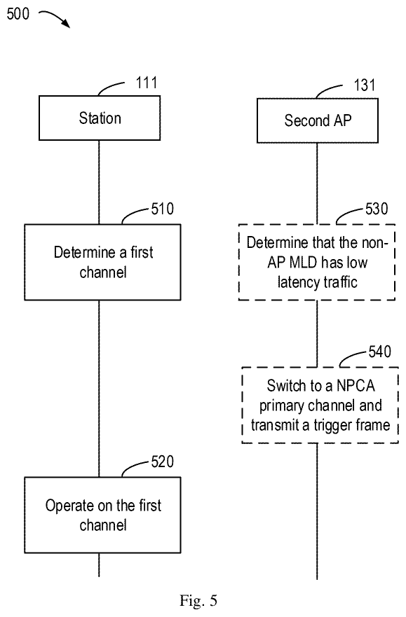

Reference is now made to FIG. 5, which shows a process 500 for first channel determination based on capability and enablement of AP MLD according to some embodiments of the present disclosure. For the purpose of discussion, the process 500 will be described with reference to FIG. 1A. The process 500 may involve the station 111 and the second AP 131 as illustrated in FIG. 1A.

At 510, the station 111 may determine a first channel that the second AP 131 is actively using based on at least a condition that the station 111 does not detect any transmissions from the second AP 131 after a non-AP MLD 110 receives seamless roaming response from a first AP MLD, and does not detect any OBSS on the primary channel of the second AP 131. The non-AP MLD 110 is currently associated with the first AP MLD 120. The second AP MLD 130 is an AP MLD to which the non-AP MLD 110 is intended to be associated, and the first channel is the primary channel of the second AP 131 or a NPCA primary channel of the second AP 131. At 520, the station 111 may operate on the first channel.

In some embodiments, the non-AP MLD 110 may support and use seamless roaming, and the station 111 may support and enable NPCA.

In some embodiments, the non-AP MLD 110 may use seamless roaming for transitioning the link from the first AP MLD 120 to the second AP MLD 130, and the non-AP MLD 110 does not detect any transmissions from the second AP 131 after the non-AP MLD 110 receives a seamless roaming response from the first AP MLD 120, but also does not detect any OBSS on the primary channel of the second AP 131.

In some embodiments, the station 111 may determine the first channel by: listening to the primary channel of the second AP 131; and determining the first channel to be the primary channel of the second AP 131 based on having detected a transmission on the primary channel; or listening to the NPCA primary channel of the second AP 131 based on having not detected any transmissions on the primary channel within a first period, and determining the first channel to be the NPCA primary channel of the second AP 131 based on having detected a transmission on the NPCA primary channel. And then, the station 111 may determine the first channel based on the condition.

In some embodiments, the station 111 may determine the first channel by: listening to primary channel of the second AP 131 and the NPCA primary channel of the second AP 131; and determining the first channel to be the primary channel of the second AP 131 based on having detected a transmission on the primary channel; or determining the first channel to be the NPCA primary channel of the second AP 131 based on having detected a transmission on the NPCA primary channel. By listening to both channels simultaneously, it is allowed to immediately determine which channel the second AP MLD 130 is actively using.

In some embodiments, the transmission on the NPCA primary channel may comprise a trigger frame transmitted by the second AP.

In some embodiments, at 530, the second AP 131 may determine that the non-AP MLD 110 has low latency traffic, wherein the non-AP MLD 110 intends to be associated with the second AP MLD 130.

In some embodiments, at 540, the second AP 131 may switch to a NPCA primary channel before receiving a transmission from the station 111 and transmit a trigger frame on the NPCA primary channel repeatedly with a periodicity for a period or until a transmission from the station 111 is received based on the determination.

In some embodiments, the determination is based on information from the first AP MLD 120.

In some embodiments, the information may comprise context transfer or other information.

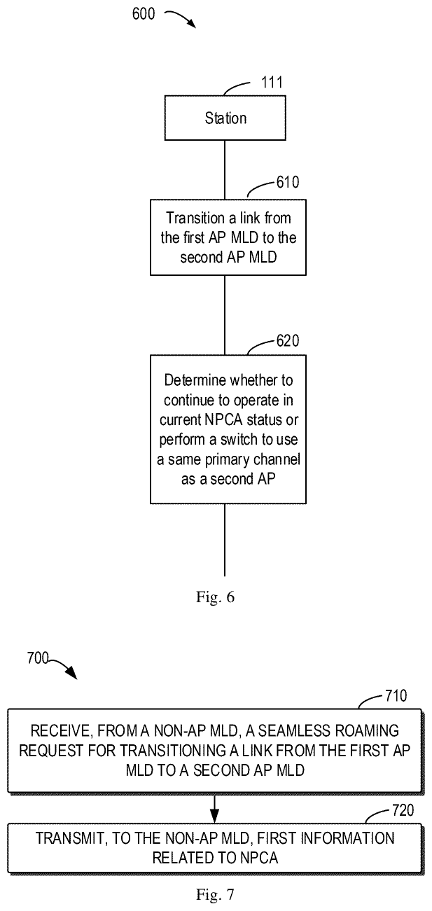

Reference is now made to FIG. 6, which shows a process 600 for NPCA status determination based on capability and enablement of AP MLD according to some embodiments of the present disclosure. For the purpose of discussion, the process 600 will be described with reference to FIG. 1A. The process 600 may involve the station 111 as illustrated in FIG. 1A.

At 610, the station 111 may transition a link from the first AP MLD 120 to the second AP MLD 130.

At 620, the station 111 may determine whether to continue to operate in current NPCA status or perform a switch to use a same primary channel as a second AP affiliated with the second AP MLD based on a RU index from a transmission by the second AP.

In some embodiments, the non-AP MLD 110 may support and use seamless roaming, and the station 111 may support and enable NPCA.

In some embodiments, when the non-AP MLD 110 uses seamless roaming for transitioning the link from the first AP MLD 120 to the second AP MLD 130, the station 111 may maintain its NPCA status after roaming. For example, if the station 111 was operating on the primary channel when connected with the first AP MLD 120, the station 111 may continue to operate on the primary channel when establishing connection or a transmission with the second AP MLD 130, and if the station 111 was operating on the NPCA primary channel, the station 111 may continue to operate on the NPCA primary channel.

In some embodiments, the station 111 may determine to continue to operate in current NPCA status based on a condition that the RU index confirms that a current primary channel is same as the second AP.

In some embodiments, the station 111 may determine to switch from the NPCA primary channel to the primary channel based on a condition that the RU index confirms that a current primary channel used is not same as the second AP. That is, the station 111 may not switch channel.

In some embodiments, the station 111 may determine to switch from the primary channel to the NPCA primary channel based on a condition that the RU index confirms that a current primary channel is not same as the second AP.

In some embodiments, the station 111 may determine to switch from the primary channel to the NPCA primary channel further based on a determination that a basic NAV of an OBSS affecting the primary channel of the second AP is longer than a second value.

In some embodiments, the basic NAV is retrieved in a seamless roaming response from the first AP MLD when requesting to roam.

In some embodiments, the station 111 may determine to switch to the primary channel based on a determination that a basic NAV of an OBSS affecting the primary channel of the second AP is shorter than a second value.

With the process 600, regardless of whether upon roaming the station 111 operates on the reference primary or NPCA primary channel of the second AP 130, the non-AP MLD 110 may check the RU index information received from the second AP MLD 130: if the non-AP MLD 110 is able to retrieve this information (this is possible if a wide-bandwidth transmission occurs covering both NPCA primary and reference primary of the AP affiliated with current AP MLD), the station 111 may decide on whether to continue to operate in current NPCA status (either continue to operate in the reference primary or NPCA primary channel) or perform a switch (either switch to the NPCA primary channel or switch back to the reference primary channel, respectively) to consistently use the same primary channel (e.g., reference primary channel or NPCA primary channel) as the second AP 131.

FIG. 7 shows a flowchart of an example method 700 implemented an apparatus in accordance with some embodiments of the present disclosure. For the purpose of discussion, the method 700 will be described from the perspective of the first AP MLD 120 with reference to FIG. 1A.

At block 710, the first AP MLD 120 may receive, from a non-AP MLD, a seamless roaming request for transitioning a link from the first AP MLD 120 to a second AP MLD.

At block 720, the first AP MLD 120 may transmit, to the non-AP MLD, first information related to NPCA.

In some embodiments, the first information may comprise: a NPCA capability of a second AP affiliated with the second AP MLD; a NPCA primary channel used by the second AP; operating bandwidth used by the second AP when switching to a NPCA primary channel; a NAV of an OBSS detected by the second AP and overlapping with its NPCA primary channel; whether or not the second AP is currently operating on a NPCA primary channel or a primary channel; or any combination thereof.

In some embodiments, the first information may be carried on an ICR or ICF between the first AP MLD 120 and the non-AP MLD, a neighbors report, or a response of the seamless roaming request.

In some embodiments, the first AP MLD 120 may transmit, to the second AP MLD, second information related to NPCA.

In some embodiments, the second information may comprise: a NPCA capability of a first AP affiliated with the first AP MLD 120; a NPCA primary channel used by the first AP; operating bandwidth used by the first AP when switching to a NPCA primary channel; a NAV of an OBSS detected by the first AP and overlapping with its NPCA primary channel; or whether or not the first AP is currently operating on a NPCA primary channel or a primary channel; or any combination thereof.

In some embodiments, the second information is carried on a context transfer message.

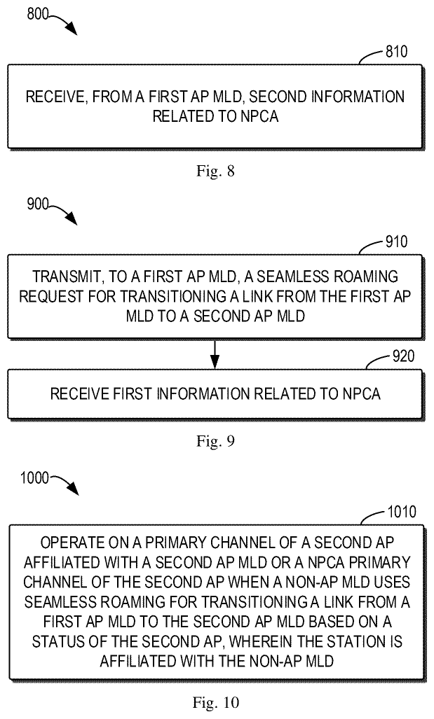

FIG. 8 shows a flowchart of an example method implemented at an apparatus in accordance with some embodiments. For the purpose of discussion, an example method 800 will be described from the perspective of the second AP MLD 130 with reference to FIG. 1A.

At block 810, the second AP MLD 130 may receive, from a first AP MLD, second information related to NPCA.

In some embodiments, the second information may comprise: a NPCA capability of a first AP affiliated with the first AP MLD; a NPCA primary channel used by the first AP; operating bandwidth used by the first AP when switching to a NPCA primary channel; a NAV of an OBSS detected by the first AP and overlapping with its NPCA primary channel; whether or not the first AP is currently operating on a NPCA primary channel or a primary channel; or any combination thereof.

In some embodiments, the second information is carried on a context transfer message.

In some embodiments, the second AP MLD 130 may transmit, to the first AP MLD, first information related to NPCA.

In some embodiments, the second AP MLD 130 may transmit, to the non-AP MLD, first information related to NPCA.

In some embodiments, the first information is carried on a beacon frame or a management frame.

In some embodiments, the first information may comprise: a NPCA capability of a second AP affiliated with the second AP MLD 130; a NPCA primary channel used by the second AP; operating bandwidth used by the second AP when switching to a NPCA primary channel; a NAV of an OBSS detected by the second AP and overlapping with its NPCA primary channel; whether or not the second AP is currently operating on a NPCA primary channel or a primary channel; or any combination thereof.

FIG. 9 shows a flowchart of an example method implemented at an apparatus in accordance with some embodiments. For the purpose of discussion, an example method 900 will be described from the perspective of the non-AP MLD 110 with reference to FIG. 1A.

At block 910, the non-AP MLD 110 may transmit, to a first AP MLD, a seamless roaming request for transitioning a link from the first AP MLD to a second AP MLD.

At block 920, the non-AP MLD 110 may receive first information related to NPCA.

In some embodiments, the first information may comprise: a NPCA capability of a second AP affiliated with the second AP MLD; a NPCA primary channel used by the second AP; operating bandwidth used by the second AP when switching to a NPCA primary channel; a NAV of an OBSS detected by the second AP and overlapping with its NPCA primary channel; whether or not the second AP is currently operating on a NPCA primary channel or a primary channel; or any combination thereof.

In some embodiments, the first information is carried on an ICR or ICF between the first AP MLD and the non-AP MLD 110, a beacon frame, a management frame, a neighbors report, or a response of the seamless roaming request.

In some embodiments, the first information is received from the first AP MLD or the second AP MLD.

FIG. 10 shows a flowchart of an example method implemented at an apparatus in accordance with some embodiments. For the purpose of discussion, an example method 1000 will be described from the perspective of the station 111 with reference to FIG. 1A.

At block 1010, the station 111 may operate on a primary channel of a second AP affiliated with a second AP MLD or a NPCA primary channel of the second AP when a non-AP MLD uses seamless roaming for transitioning a link from a first AP MLD to the second AP MLD based on a status of the second AP, wherein the station 111 is affiliated with the non-AP MLD.

In some embodiments, the station 111 may operate on the primary channel of the second AP regardless of a state of the station 111 when connected with the first AP MLD.

In some embodiments, the station 111 may switch to operate on a NPCA primary channel of the second AP based on a condition that the station 111 having detected an OBSS which overlaps with the primary channel of the second AP.

In some embodiments, the station 111 may operate on the NPCA primary channel of the second AP based on a condition that both the station 111 and the second AP are operating on the same NPCA primary channel.

In some embodiments, the station 111 may update a basic NAV of an OBSS through: assessment of the OBSS; or information from an ICR or ICF between the first AP MLD and the non-AP MLD, a beacon frame, a management frame, neighbors report, or a seamless roaming response from the first AP MLD to the non-AP MLD when requesting to roam.

In some embodiments, the station 111 may operate on the primary channel of the second AP based on a condition that the station 111 and the second AP are operating on different NPCA primary channels.

In some embodiments, the station 111 may operate on the NPCA primary channel of the second AP based on a condition that the station 111 and the second AP are operating on different NPCA primary channels.

In some embodiments, the station 111 may update a basic NAV of an OBSS through: assessment of the OBSS; or information from a seamless roaming response from the first AP MLD when requesting to roam.

In some embodiments, the station 111 may operate on the NPCA primary channel of the second AP based on a condition that a basic NAV of an OBSS affecting the primary channel of the second AP, which is retrieved in a seamless roaming response from the first AP MLD when requesting to roam, is longer than a first value.

In some embodiments, the station 111 may operate on the primary channel of the second AP based on a condition that a basic NAV of an OBSS affecting the primary channel of the second AP, which is retrieved in a seamless roaming response from the first AP MLD when requesting to roam, is shorter than a first value.

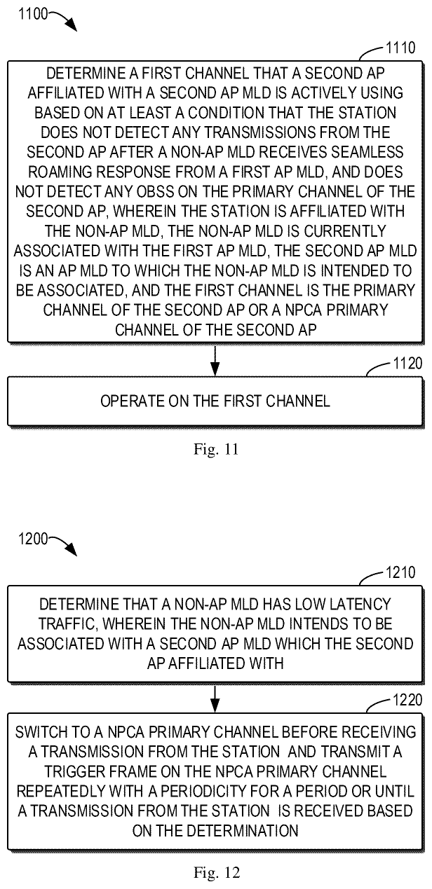

FIG. 11 shows a flowchart of an example method implemented at an apparatus in accordance with some embodiments. For the purpose of discussion, an example method 1100 will be described from the perspective of the station 111 with reference to FIG. 1A.

At block 1110, the station 111 may determine a first channel that a second AP affiliated with a second AP MLD is actively using based on at least a condition that the station 111 does not detect any transmissions from the second AP after a non-AP MLD receives seamless roaming response from a first AP MLD, and does not detect any OBSS on the primary channel of the second AP, wherein the station 111 is affiliated with the non-AP MLD, the non-AP MLD is currently associated with the first AP MLD, the second AP MLD is an AP MLD to which the non-AP MLD is intended to be associated, and the first channel is the primary channel of the second AP or a NPCA primary channel of the second AP.

At block 1120, the station 111 may operate on the first channel.

In some embodiments, the station 111 may determine the first channel by: listening to the primary channel of the second AP; and determining the first channel to be the primary channel of the second AP based on having detected a transmission on the primary channel; or listening to the NPCA primary channel of the second AP based on having not detected any transmissions on the primary channel within a first period, and determining the first channel to be the NPCA primary channel of the second AP based on having detected a transmission on the NPCA primary channel.

In some embodiments, the station 111 may determine the first channel by: listening to primary channel of the second AP and the NPCA primary channel of the second AP; and determining the first channel to be the primary channel of the second AP based on having detected a transmission on the primary channel; or determining the first channel to be the NPCA primary channel of the second AP based on having detected a transmission on the NPCA primary channel.

In some embodiments, the transmission on the NPCA primary channel may comprise a trigger frame transmitted by the second AP.

FIG. 12 shows a flowchart of an example method implemented at an apparatus in accordance with some embodiments. For the purpose of discussion, an example method 1200 will be described from the perspective of the second AP 131 with reference to FIG. 1A.

At block 1210, the second AP 131 may determine that a non-AP MLD has low latency traffic, wherein the non-AP MLD intends to be associated with a second AP MLD which the second AP 131 affiliated with.

At block 1220, the second AP 131 may switch to a NPCA primary channel before receiving a transmission from the station 111 and transmit a trigger frame on the NPCA primary channel repeatedly with a periodicity for a period or until a transmission from the station 111 is received based on the determination.

In some embodiments, the determination is based on information from a first AP MLD.

In some embodiments, the information may comprise context transfer.

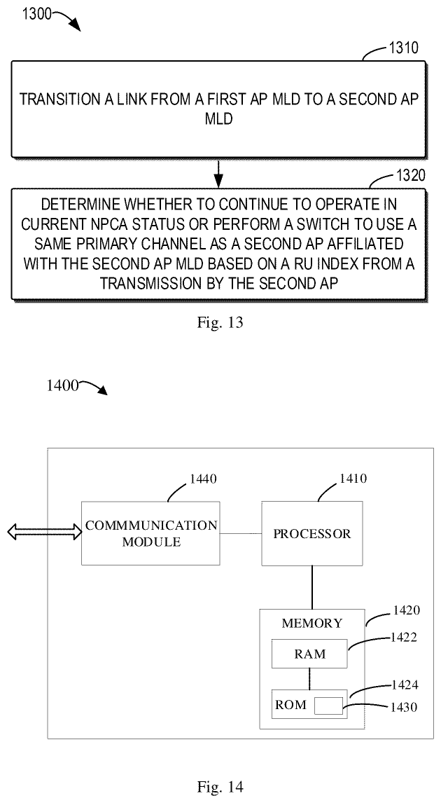

FIG. 13 shows a flowchart of an example method implemented at an apparatus in accordance with some embodiments. For the purpose of discussion, an example method 1300 will be described from the perspective of the station 111 with reference to FIG. 1A.

At block 1310, the station 111 may transition a link from a first AP MLD to a second AP MLD.

At block 1320, the station 111 may determine whether to continue to operate in current NPCA status or perform a switch to use a same primary channel as a second AP affiliated with the second AP MLD based on a RU index from a transmission by the second AP.

In some embodiments, the station 111 may determine to continue to operate in current NPCA status based on a condition that the RU index confirms that a current primary channel is same as the second AP.

In some embodiments, the station 111 may determine to switch from the NPCA primary channel to the primary channel based on a condition that the RU index confirms that a current primary channel used is not same as the second AP.

In some embodiments, the station 111 may determine to switch from the primary channel to the NPCA primary channel based on a condition that the RU index confirms that a current primary channel is not same as the second AP.

In some embodiments, the station 111 may determine to switch from the primary channel to the NPCA primary channel further based on a determination that a basic NAV of an OBSS affecting the primary channel of the second AP is longer than a second value.

In some embodiments, the basic NAV is retrieved in a seamless roaming response from the first AP MLD when requesting to roam.

In some embodiments, the apparatus further comprises means for performing other steps in some embodiments of the method 700. In some embodiments, the means comprises at least one processor and at least one memory including computer program code, the at least one memory and computer program code configured to, with the at least one processor, cause the performance of the apparatus.

In some embodiments, an apparatus capable of performing any of the method 800 (for example, the second AP MLD 130) may comprise means for performing the respective steps of the method 800. The means may be implemented in any suitable form. For example, the means may be implemented in a circuitry or software module.

In some embodiments, the apparatus comprises: means for receiving, from a first AP MLD, second information related to NPCA.

In some embodiments, the second information may comprise: a NPCA capability of a first AP affiliated with the first AP MLD; a NPCA primary channel used by the first AP; operating bandwidth used by the first AP when switching to a NPCA primary channel; a NAV of an OBSS detected by the first AP and overlapping with its NPCA primary channel; whether or not the first AP is currently operating on a NPCA primary channel or a primary channel; or any combination thereof.

In some embodiments, the second information is carried on a context transfer message.

In some embodiments, the apparatus further comprises means for transmitting, to the first AP MLD, first information related to NPCA.

In some embodiments, the apparatus further comprises means for transmitting, to the non-AP MLD, first information related to NPCA.

In some embodiments, the first information is carried on a beacon frame or a management frame.

In some embodiments, the first information may comprise: a NPCA capability of a second AP affiliated with the apparatus; a NPCA primary channel used by the second AP; operating bandwidth used by the second AP when switching to a NPCA primary channel; a NAV of an OBSS detected by the second AP and overlapping with its NPCA primary channel; whether or not the second AP is currently operating on a NPCA primary channel or a primary channel; or any combination thereof.

In some embodiments, the apparatus is an AP MLD.

In some embodiments, the apparatus further comprises means for performing other steps in some embodiments of the method 800. In some embodiments, the means comprises at least one processor and at least one memory including computer program code, the at least one memory and computer program code configured to, with the at least one processor, cause the performance of the apparatus.

In some embodiments, an apparatus capable of performing any of the method 900 (for example, the non-AP MLD 110) may comprise means for performing the respective steps of the method 900. The means may be implemented in any suitable form. For example, the means may be implemented in a circuitry or software module.

In some embodiments, the apparatus comprises: means for transmitting, to a first AP MLD, a seamless roaming request for transitioning a link from the first AP MLD to a second AP MLD; and means for receiving first information related to NPCA.

In some embodiments, the first information may comprise: a NPCA capability of a second AP affiliated with the second AP MLD; a NPCA primary channel used by the second AP; operating bandwidth used by the second AP when switching to a NPCA primary channel; a NAV of an OBSS detected by the second AP and overlapping with its NPCA primary channel; whether or not the second AP is currently operating on a NPCA primary channel or a primary channel; or any combination thereof.

In some embodiments, the first information is carried on an ICR or ICF between the first AP MLD and the apparatus, a beacon frame, a management frame, a neighbors report, or a response of the seamless roaming request.

In some embodiments, the first information is received from the first AP MLD or the second AP MLD.

In some embodiments, the apparatus is a non-AP MLD.

In some embodiments, the apparatus further comprises means for performing other steps in some embodiments of the method 900. In some embodiments, the means comprises at least one processor and at least one memory including computer program code, the at least one memory and computer program code configured to, with the at least one processor, cause the performance of the apparatus.

In some embodiments, an apparatus capable of performing any of the method 1000 (for example, the station 111) may comprise means for performing the respective steps of the method 1000. The means may be implemented in any suitable form. For example, the means may be implemented in a circuitry or software module.

In some embodiments, the apparatus comprises: means for operating on a primary channel of a second AP affiliated with a second AP MLD or a NPCA primary channel of the second AP when a non-AP MLD uses seamless roaming for transitioning a link from a first AP MLD to the second AP MLD based on a status of the second AP, wherein the apparatus is affiliated with the non-AP MLD.

In some embodiments, the apparatus further comprises means for operating on the primary channel of the second AP regardless of a state of the apparatus when connected with the first AP MLD.

In some embodiments, the apparatus further comprises means for switching to operate on a NPCA primary channel of the second AP based on a condition that the apparatus having detected an OBSS which overlaps with the primary channel of the second AP.

In some embodiments, the apparatus further comprises means for operating on the NPCA primary channel of the second AP based on a condition that both the apparatus and the second AP are operating on the same NPCA primary channel.

In some embodiments, the apparatus further comprises means for updating a basic NAV of an OBSS through: assessment of the OBSS; or information from an ICR or ICF between the first AP MLD and the non-AP MLD, a beacon frame, a management frame, neighbors report, or a seamless roaming response from the first AP MLD to the non-AP MLD when requesting to roam.

In some embodiments, the apparatus further comprises means for operating on the primary channel of the second AP based on a condition that the apparatus and the second AP are operating on different NPCA primary channels.

In some embodiments, the apparatus further comprises means for operating on the NPCA primary channel of the second AP based on a condition that the apparatus and the second AP are operating on different NPCA primary channels.

In some embodiments, the apparatus further comprises means for updating a basic NAV of an OBSS through: assessment of the OBSS; or information from a seamless roaming response from the first AP MLD when requesting to roam.

In some embodiments, the apparatus further comprises means for operating on the NPCA primary channel of the second AP based on a condition that a basic NAV of an OBSS affecting the primary channel of the second AP, which is retrieved in a seamless roaming response from the first AP MLD when requesting to roam, is longer than a first value.

In some embodiments, the apparatus further comprises means for operating on the primary channel of the second AP based on a condition that a basic NAV of an OBSS affecting the primary channel of the second AP, which is retrieved in a seamless roaming response from the first AP MLD when requesting to roam, is shorter than a first value.

In some embodiments, the apparatus is a station.

In some embodiments, the apparatus further comprises means for performing other steps in some embodiments of the method 1000. In some embodiments, the means comprises at least one processor and at least one memory including computer program code, the at least one memory and computer program code configured to, with the at least one processor, cause the performance of the apparatus.

In some embodiments, an apparatus capable of performing any of the method 1100 (for example, the station 111) may comprise means for performing the respective steps of the method 1100. The means may be implemented in any suitable form. For example, the means may be implemented in a circuitry or software module.

In some embodiments, the apparatus comprises: means for determining a first channel that a second AP affiliated with a second AP MLD is actively using based on at least a condition that the apparatus does not detect any transmissions from the second AP after a non-AP MLD receives seamless roaming response from a first AP MLD, and does not detect any OBSS on the primary channel of the second AP, wherein the apparatus is affiliated with the non-AP MLD, the non-AP MLD is currently associated with the first AP MLD, the second AP MLD is an AP MLD to which the non-AP MLD is intended to be associated, and the first channel is the primary channel of the second AP or a NPCA primary channel of the second AP; and means for operate on the first channel.

In some embodiments, the apparatus further comprises means for listening to the primary channel of the second AP; and means for determining the first channel to be the primary channel of the second AP based on having detected a transmission on the primary channel; or means for listening to the NPCA primary channel of the second AP based on having not detected any transmissions on the primary channel within a first period, and means for determining the first channel to be the NPCA primary channel of the second AP based on having detected a transmission on the NPCA primary channel.

In some embodiments, the apparatus further comprises means for listening to primary channel of the second AP and the NPCA primary channel of the second AP; and means for determining the first channel to be the primary channel of the second AP based on having detected a transmission on the primary channel; or means for determining the first channel to be the NPCA primary channel of the second AP based on having detected a transmission on the NPCA primary channel.

In some embodiments, the transmission on the NPCA primary channel may comprise a trigger frame transmitted by the second AP.

In some embodiments, the apparatus is a station.

In some embodiments, the apparatus further comprises means for performing other steps in some embodiments of the method 1100. In some embodiments, the means comprises at least one processor and at least one memory including computer program code, the at least one memory and computer program code configured to, with the at least one processor, cause the performance of the apparatus.

In some embodiments, an apparatus capable of performing any of the method 1200 (for example, the second AP 131) may comprise means for performing the respective steps of the method 1200. The means may be implemented in any suitable form. For example, the means may be implemented in a circuitry or software module.

In some embodiments, the apparatus comprises: means for determining that a non-AP MLD has low latency traffic, wherein the non-AP MLD intends to be associated with a second AP MLD which the apparatus affiliated with; and means for switching to a NPCA primary channel before receiving a transmission from a station affiliated with the non-AP MLD and transmitting a trigger frame on the NPCA primary channel repeatedly with a periodicity for a period or until a transmission from the station affiliated with the non-AP MLD is received based on the determination.

In some embodiments, the determination is based on information from a first AP MLD.

In some embodiments, the information may comprise context transfer.

In some embodiments, the apparatus is an AP.

In some embodiments, the apparatus further comprises means for performing other steps in some embodiments of the method 1200. In some embodiments, the means comprises at least one processor and at least one memory including computer program code, the at least one memory and computer program code configured to, with the at least one processor, cause the performance of the apparatus.

In some embodiments, an apparatus capable of performing any of the method 1300 (for example, the station 111) may comprise means for performing the respective steps of the method 1300. The means may be implemented in any suitable form. For example, the means may be implemented in a circuitry or software module.

In some embodiments, the apparatus comprises: means for transition a link from a first AP MLD to a second AP MLD; and means for determining whether to continue to operate in current NPCA status or perform a switch to use a same primary channel as a second AP affiliated with the second AP MLD based on a RU index from a transmission by the second AP.

In some embodiments, the apparatus further comprises means for determining to continue to operate in current NPCA status based on a condition that the RU index confirms that a current primary channel is same as the second AP.

In some embodiments, the apparatus further comprises means for determining to switch from the NPCA primary channel to the primary channel based on a condition that the RU index confirms that a current primary channel used is not same as the second AP.

In some embodiments, the apparatus further comprises means for determining to switch from the primary channel to the NPCA primary channel based on a condition that the RU index confirms that a current primary channel is not same as the second AP.

In some embodiments, the apparatus further comprises means for determining to switch from the primary channel to the NPCA primary channel further based on a determination that a basic NAV of an OBSS affecting the primary channel of the second AP is longer than a second value.

In some embodiments, the basic NAV is retrieved in a seamless roaming response from the first AP MLD when requesting to roam.

In some embodiments, the apparatus is a station.

In some embodiments, the apparatus further comprises means for performing other steps in some embodiments of the method 1300. In some embodiments, the means comprises at least one processor and at least one memory including computer program code, the at least one memory and computer program code configured to, with the at least one processor, cause the performance of the apparatus.

FIG. 14 is a simplified block diagram of an example apparatus 1400 that is suitable for implementing embodiments. The apparatus 1400 may be provided to implement the communication device, for example the first AP MLD 120, the second AP MLD 130, the non-AP MLD 110, the station 111 as shown in FIG. 1. As shown, the apparatus 1400 includes one or more processors 1410, one or more memories 1420 coupled to the processor 1410, and one or more communication modules 1440 coupled to the processor 1410.

The communication module 1440 is for bidirectional communications. The communication module 1440 has at least one antenna to facilitate communication. The communication interface may represent any interface that is necessary for communication with other network elements.

The processor 1410 may be of any type suitable to the local technical network and may include one or more of the following: general purpose computers, special purpose computers, microprocessors, digital signal processors (DSPs) and processors based on multicore processor architecture, as non-limiting examples. The apparatus 1400 may have multiple processors, such as an application specific integrated circuit chip that is slaved in time to a clock which synchronizes the main processor.

The memory 1420 may include one or more non-volatile memories and one or more volatile memories. Examples of the non-volatile memories include, but are not limited to, a read only memory (ROM) 1424, an electrically programmable read only memory (EPROM), a flash memory, a hard disk, a compact disc (CD), a digital video disk (DVD), and other magnetic storage and/or optical storage. Examples of the volatile memories include, but are not limited to, a random access memory (RAM) 1422 and other volatile memories that will not persist after a power-down duration.

A computer program 1430 includes computer executable instructions that are executed by the associated processor 1410. The program 1430 may be stored in the ROM 1424. The processor 1410 may perform any suitable actions and processing by loading the program 1430 into the RAM 1422.

The communication module 1440 is for bidirectional communications. The communication module 1440 has at least one antenna to facilitate communication. The communication interface may represent any interface that is necessary for communication with other network elements.

The various embodiments of this disclosure may be implemented by means of the program 1430 so that the apparatus 1400 may perform any process of the disclosure as discussed with reference to FIGS. 2 to 13. The various embodiments of this disclosure may also be implemented by hardware or by a combination of software and hardware.

In some embodiments, the program 1430 may be tangibly contained in a computer readable medium which may be included in the apparatus 1400 (such as in the memory 1420) or other storage devices that are accessible by the apparatus 1400. The apparatus 1400 may load the program 1430 from the computer readable medium to the RAM 1422 for execution. The computer readable medium may include any types of tangible non-volatile storage, such as ROM, EPROM, a flash memory, a hard disk, CD, DVD, and the like.

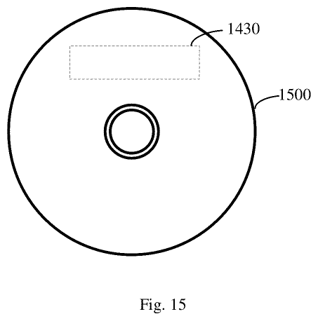

FIG. 15 illustrates a block diagram of an example computer readable medium in accordance with some embodiments. For example, FIG. 15 may show an example of a computer readable medium 1500 in form of CD or DVD. The computer readable medium may comprise the program 1430 stored thereon.

Generally, various embodiments of the present disclosure may be implemented in hardware or special purpose circuits, software, logic or any combination thereof. Some aspects may be implemented in hardware, while other aspects may be implemented in firmware or software which may be executed by a controller, microprocessor or other computing device. While various aspects of embodiments of the present disclosure are illustrated and described as block diagrams, flowcharts, or using some other pictorial representations, it is to be understood that the block, apparatus, system, technique or method described herein may be implemented in, as non-limiting examples, hardware, software, firmware, special purpose circuits or logic, general purpose hardware or controller or other computing devices, or some combination thereof.

The present disclosure also provides at least one computer program product tangibly stored on a non-transitory computer readable storage medium. The computer program product includes computer-executable instructions, such as those included in program modules, being executed in a device on a target real or virtual processor, to carry out the method as described above with reference to FIGS. 2-13. Generally, program modules include routines, programs, libraries, objects, classes, components, data structures, or the like that perform particular tasks or implement particular abstract data types. The functionality of the program modules may be combined or split between program modules as desired in various embodiments. Machine-executable instructions for program modules may be executed within a local or distributed device. In a distributed device, program modules may be located in both local and remote storage media.

Program code for carrying out methods of the present disclosure may be written in any combination of one or more programming languages. These program codes may be provided to a processor or controller of a general purpose computer, special purpose computer, or other programmable data processing apparatus, such that the program codes, when executed by the processor or controller, cause the functions/operations specified in the flowcharts and/or block diagrams to be implemented. The program code may execute entirely on a machine, partly on the machine, as a stand-alone software package, partly on the machine and partly on a remote machine or entirely on the remote machine or server.

In the context of the present disclosure, the computer program codes or related data may be carried by any suitable carrier to enable the device, apparatus or processor to perform various processes and operations as described above. Examples of the carrier include a signal, computer readable medium, and the like.

The computer readable medium may be a computer readable signal medium or a computer readable storage medium. A computer readable medium may include but not limited to an electronic, magnetic, optical, electromagnetic, infrared, or semiconductor system, apparatus, or device, or any suitable combination of the foregoing. More specific examples of the computer readable storage medium would include an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. The term “non-transitory,” as used herein, is a limitation of the medium itself (i.e., tangible, not a signal) as opposed to a limitation on data storage persistency (e.g., RAM vs. ROM).

Further, while operations are depicted in a particular order, this should not be understood as requiring that such operations be performed in the particular order shown or in sequential order, or that all illustrated operations be performed, to achieve desirable results. In certain circumstances, multitasking and parallel processing may be advantageous. Likewise, while several specific implementation details are contained in the above discussions, these should not be construed as limitations on the scope of the present disclosure, but rather as descriptions of features that may be specific to particular embodiments. Certain features that are described in the context of separate embodiments may also be implemented in combination in a single embodiment. Conversely, various features that are described in the context of a single embodiment may also be implemented in multiple embodiments separately or in any suitable sub-combination.

Although the present disclosure has been described in languages specific to structural features and/or methodological acts, it is to be understood that the present disclosure defined in the appended claims is not necessarily limited to the specific features or acts described above. Rather, the specific features and acts described above are disclosed as example forms of implementing the claims.

What is claimed is:

1. An apparatus comprising:
at least one processor; and
at least one memory storing instructions that, when executed by the at least one processor, cause the apparatus at least to:
receive, from a non-access-point (AP) multi-link device (MLD), a seamless roaming request for transitioning a link from the apparatus to a second AP MLD; and
transmit, to the non-AP MLD, first information related to non-primary channel access (NPCA).

2. The apparatus of claim 1, wherein the first information comprises at least one of the following:
a NPCA capability of a second AP affiliated with the second AP MLD;
a NPCA primary channel used by the second AP;
operating bandwidth used by the second AP when switching to a NPCA primary channel;
a network allocation vector (NAV) of an overlapping basic service set (OBSS) detected by the second AP and overlapping with its NPCA primary channel; or
whether or not the second AP is currently operating on a NPCA primary channel or a primary channel.

3. The apparatus of claim 1 or 2, wherein the first information is carried on an initial control response (ICR) or initial control frame (ICF) between the apparatus and the non-AP MLD, a neighbors report, or a response of the seamless roaming request.

4. The apparatus of any of claims 1-3, wherein the apparatus is further caused to:
transmit, to the second AP MLD, second information related to NPCA.

5. The apparatus of claim 4, wherein the second information comprises at least one of the following:
a NPCA capability of a first AP affiliated with the apparatus;
a NPCA primary channel used by the first AP;
operating bandwidth used by the first AP when switching to a NPCA primary channel;
a NAV of an OBSS detected by the first AP and overlapping with its NPCA primary channel; or
whether or not the first AP is currently operating on a NPCA primary channel or a primary channel.

6. The apparatus of claim 4 or 5, wherein the second information is carried on a context transfer message.

7. The apparatus of any of claims 1-6, wherein the apparatus is an AP MLD.

8. An apparatus comprising:
at least one processor; and
at least one memory storing instructions that, when executed by the at least one processor, cause the apparatus at least to:
receive, from a first access-point (AP) multi-link device (MLD), second information related to non-primary channel access (NPCA).

9. The apparatus of claim 8, wherein the second information comprises at least one of the following:
a NPCA capability of a first AP affiliated with the first AP MLD;
a NPCA primary channel used by the first AP;
operating bandwidth used by the first AP when switching to a NPCA primary channel;
a network allocation vector (NAV) of an overlapping basic service set (OBSS) detected by the first AP and overlapping with its NPCA primary channel; or
whether or not the first AP is currently operating on a NPCA primary channel or a primary channel.

10. The apparatus of claim 8 or 9, wherein the second information is carried on a context transfer message.

11. The apparatus of any of claims 8-10, wherein the apparatus is an AP MLD.

12. An apparatus comprising:
at least one processor; and
at least one memory storing instructions that, when executed by the at least one processor, cause the apparatus at least to:
transmit, to a first access-point (AP) multi-link device (MLD), a seamless roaming request for transitioning a link from the first AP MLD to a second AP MLD; and
receive first information related to non-primary channel access (NPCA).

13. The apparatus of claim 12, wherein the first information comprises at least one of the following:
a NPCA capability of a second AP affiliated with the second AP MLD;
a NPCA primary channel used by the second AP;
operating bandwidth used by the second AP when switching to a NPCA primary channel;
a network allocation vector (NAV) of an overlapping basic service set (OBSS) detected by the second AP and overlapping with its NPCA primary channel; or
whether or not the second AP is currently operating on a NPCA primary channel or a primary channel.

14. The apparatus of claim 12 or 13, wherein the first information is carried on an initial control response (ICR) or initial control frame (ICF) between the first AP MLD and the apparatus, a beacon frame, a management frame, a neighbors report, or a response of the seamless roaming request.

15. The first apparatus of any of claims 12-14, wherein the first information is received from the first AP MLD or the second AP MLD.

16. The apparatus of any of claims 12-15, wherein the apparatus is a non-AP MLD.

17. An apparatus comprising:
at least one processor; and
at least one memory storing instructions that, when executed by the at least one processor, cause the apparatus at least to:
operate on a primary channel of a second access-point (AP) affiliated with a second AP multi-link device (MLD) or a non-primary channel access (NPCA) primary channel of the second AP when a non-AP MLD uses seamless roaming for transitioning a link from a first AP MLD to the second AP MLD based on a status of the second AP, wherein the apparatus is affiliated with the non-AP MLD.

18. The apparatus of claim 17, wherein the apparatus is caused to operate on the primary channel of the second AP regardless of a state of the apparatus when connected with the first AP MLD.

19. The apparatus of claim 17, wherein the apparatus is caused to operate on the NPCA primary channel of the second AP based on a condition that both the apparatus and the second AP are operating on the same NPCA primary channel.

20. The apparatus of claim 19, wherein the apparatus is further caused to:
update a basic network allocation vector (NAV) of an OBSS through at least one of the following:
assessment of the OBSS; or
information from an initial control response (ICR) or initial control frame (ICF) between the first AP MLD and the non-AP MLD, a beacon frame, a management frame, neighbors report, or a seamless roaming response from the first AP MLD to the non-AP MLD when requesting to roam.

21. The apparatus of any of claims 17-20, wherein the apparatus is a station.

22. A method comprising:
receiving, from a non-access-point (AP) multi-link device (MLD), a seamless roaming request for transitioning a link from the apparatus to a second AP MLD; and
transmitting, to the non-AP MLD, first information related to non-primary channel access (NPCA).

23. A method comprising:
receiving, from a first access-point (AP) multi-link device (MLD), second information related to non-primary channel access (NPCA).

24. A method comprising:
transmitting, to a first access-point (AP) multi-link device (MLD), a seamless roaming request for transitioning a link from the first AP MLD to a second AP MLD; and
receiving first information related to non-primary channel access (NPCA).

25. A method comprising:
operating on a primary channel of a second access-point (AP) affiliated with a second AP multi-link device (MLD) or a non-primary channel access (NPCA) primary channel of the second AP when a non-AP MLD uses seamless roaming for transitioning a link from a first AP MLD to the second AP MLD based on a status of the second AP, wherein the apparatus is affiliated with the non-AP MLD.
